(19) United States
(12) Patent Application Publication
(10) Pub. No.: US 2026/0179168 A1
(43) Pub. Date: Jun. 25, 2026

(54) PERFORMANCE QUERIES IN GRAPHICS PROCESSING

(71) Applicant: Arm Limited, Cambridge (GB)

(72) Inventors: Olof Henrik UHRENHOLT, Lomma (SE); Jakob Axel FRIES, Lund (SE)

(21) Appl. No.: 18/988,004

(22) Filed: Dec. 19, 2024

(51) Int. Cl. G06T 1/20

(52) U.S. Cl. CPC G06T 1/20

(57) ABSTRACT

Graphics processors and methods of operating a graphics processor for determining a performance metric of one or more draw calls. Tile-based graphics processing includes a graphics processing pipeline including a tile-based renderer that produces tiles of a render output data array, such as an output frame to be displayed.

### FIELD

The present technology relates to the processing of computer graphics, in particular to graphics processors and methods of operating a graphics processor for determining a performance metric of one or more draw calls.

### BACKGROUND

Graphics processing is generally performed by first splitting a scene (e.g. a 3D model) to be displayed onto a number of similar basic components or “primitives”, which primitives are then subjected to the desired graphics processing operations. The graphics “primitives” are usually in the form of simple polygons, such as triangles.

Once primitives and their vertices have been generated and defined, they can be further processed by a fragment processing pipeline, in order to generate the desired graphics processing output (render output), such as a frame for display.

This usually involves determining which sampling points of an array of sampling points associated with the render output area to be processed are covered by a primitive, and then determining the appearance each sampling point should have (e.g. in terms of its colour) to represent the primitive at that sampling point. These processes are commonly referred to as rasterizing and rendering, respectively.

The rendering process involves deriving the data, such as red, green and blue (RGB) colour values and an “alpha” (transparency) value, necessary to represent the primitive at the sampling points. Where necessary, newly generated data may be blended with data that has previously been generated for the sampling point in question.

In tile-based rendering, the render output is divided into a plurality of smaller regions, herein referred to as “tiles”. Each tile is rendered separately (typically one after another), and the rendered tiles are then recombined to provide the complete render output, e.g. a render pass or a frame to be displayed.

A tile-based graphics processing pipeline includes one or more so-called tile buffers that store rendered fragment data at the end of the pipeline until a given tile is completed and written out to an external memory, such as a frame buffer, for use. In some tile-based graphics processing pipelines, the rendered fragment data is compressed before being written out to the external memory.

### SUMMARY

An aspect of the present technology provides a method, a graphics processor and a non-transitory computer readable storage medium according to the appended claims.

A further aspect of the present technology provides a method of operating a tile-based graphics processor for determining a performance metric of one or more draw calls, the method comprising:

receiving, during a rendering process, a plurality of draw calls, each draw call of the plurality of draw calls comprising one or more primitives;

splitting the one or more primitives into data represented as a plurality of tiles, and performing, by the tile-based graphics processor on the data represented as a plurality of tiles, asynchronous fragment processing to generate a render output;

generating, in storage associated with the graphics processor, at least one intermediate data structure for accumulating partial results of the performance metric for each of the received plurality of draw calls;

generating per-tile partial results of the performance metric, wherein each of the per-tile partial results are associated with a respective tile of the plurality of tiles;

accumulating the per-tile partial results in the at least one intermediate data structure on a per-draw call basis to generate an accumulated value for each of the one or more draw calls; and

determining, based on the accumulated values for the one or more draw calls, the performance metric, wherein the one or more draw calls correspond to at least a subset of the received plurality of draw calls.

Optionally, the plurality of tiles correspond to portions of the render output.

Optionally, the method further comprises receiving, during the rendering process, one or more queries, wherein each query relates to a given performance metric of a respective subset of the received plurality of draw calls, wherein the method comprises, for each query, generating per-tile partial results for the given performance metric, accumulating the per-tile partial results, and determining, based on the accumulated values, the performance metric for the respective subset of draw calls.

Optionally, each query comprises a begin command and an end command.

Optionally, each begin command and each end command executes at a draw call boundary.

Optionally, at least one query of the one or more queries is an occlusion query, a primitives generated query, a pipeline statistics query or a performance statistics query.

Optionally, each query is indicative of one or more performance metrics sampled by that query, wherein the method comprises generating, in the storage associated with the graphics processor, an intermediate data structure for each performance metric sampled by the one or more queries.

Optionally, accumulating the per-tile partial results in the at least one intermediate data structure comprises, for each per-tile partial result, adding the per-tile partial result to the accumulated value in the intermediate data structure according to the draw call to which that per-tile partial result corresponds.

Optionally, accumulating the per-tile partial results in the at least one intermediate data structure comprises, for each draw call of the plurality of draw calls, using an atomic add function.

Optionally, determining the performance metric comprises performing a prefix sum for each draw call of the one or more draw calls.

Optionally, each accumulated value corresponds to one draw call of the received plurality of draw calls.

A further aspect of the present technology provides a graphics processor comprising at least one execution unit with an associated storage element, the at least one execution unit is operable to perform a method comprising:

receiving, during a rendering process, a plurality of draw calls, each draw call of the plurality of draw calls comprising one or more primitives;

splitting the one or more primitives into data represented as a plurality of tiles, and performing, by the tile-based graphics processor on the data represented as a plurality of tiles, asynchronous fragment processing to generate a render output;

generating, in the storage associated with the graphics processor, at least one intermediate data structure for accumulating partial results of the performance metric for each of the received plurality of draw calls;

generating per-tile partial results of the performance metric, wherein each of the per-tile partial results are associated with a respective tile of the plurality of tiles;

accumulating the per-tile partial results in the at least one intermediate data structure on a per-draw call basis to generate an accumulated value for each of the one or more draw calls; and

determining, based on the accumulated values for the one or more draw calls, the performance metric, wherein the one or more draw calls correspond to at least a subset of the received plurality of draw calls.

Optionally, the graphics processor is to execute a post-fix shader.

Optionally, the post-fix shader is configured to determine, based on the accumulated values, the performance metric.

A further aspect of the present technology provides a non-transitory computer readable storage medium storing software code which, when executing on a processor, performs a method of operating a graphics processor comprising at least one execution unit with an associated storage element, the at least one execution unit is operable to perform a method comprising:

receiving, during a rendering process, a plurality of draw calls, each draw call of the plurality of draw calls comprising one or more primitives;

splitting the one or more primitives into data represented as a plurality of tiles, and performing, by the tile-based graphics processor on the data represented as a plurality of tiles, asynchronous fragment processing to generate a render output;

generating, in storage associated with the graphics processor, at least one intermediate data structure for accumulating partial results of the performance metric for each of the one or more draw calls;

generating per-tile partial results of the performance metric, wherein each of the per-tile partial results are associated with a respective tile of the plurality of tiles;

accumulating the per-tile partial results in the at least one intermediate data structure on a per-draw call basis to generate an accumulated value for each of the one or more draw calls; and

determining, based on the accumulated values for the one or more draw calls, the performance metric, wherein the one or more draw calls correspond to at least a subset of the received plurality of draw calls.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary graphics processing pipeline;

FIG. 2 shows an exemplary graphics processing system;

FIG. 3 shows part of an exemplary method of operating a tile-based graphics processor for determining a performance metric of one or more draw calls;

FIG. 4 shows part of an exemplary method of operating a tile-based graphics processor for determining a performance metric of one or more draw calls;

FIG. 5 shows an exemplary intermediate data structure;

FIG. 6 shows an exemplary render pass;

FIG. 7 shows an exemplary counter context list;

FIG. 8 shows an exemplary counter context linked list; and

FIG. 9 shows an exemplary dependency graph comprising a plurality of execution jobs.

### DETAILED DESCRIPTION

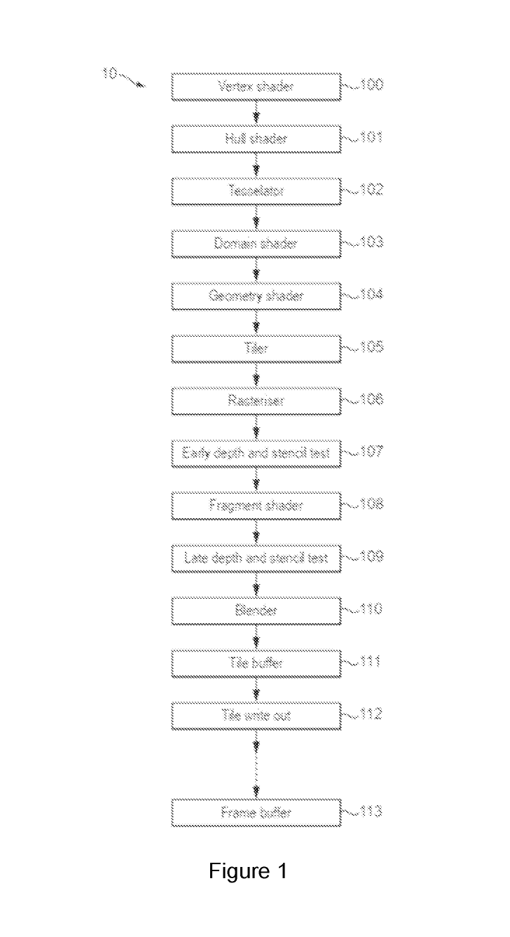

The present technology relates to tile-based graphics processing. The exemplary graphics processing pipeline 10 shown in FIG. 1 is a tile-based renderer that produces tiles of a render output data array, such as an output frame to be displayed.

FIG. 1 shows the main elements and pipeline stages of the graphics processing pipeline 10. As will be appreciated by those skilled in the art, there may be other elements of the graphics processing pipeline that are not shown in FIG. 1. It should be noted here that FIG. 1 is only schematic, and that, for example, in practice, the shown functional units and pipeline stages may share significant hardware circuits, even though they are shown functionally as separate states in FIG. 1. It will also be appreciated that each of the stages, elements and units, etc., of the graphics processing pipeline 10 may be implemented as desired and may accordingly comprise, e.g., appropriate circuitry and/or processing logic, etc., for performing the necessary operation and functions.

The graphics processing pipeline 10 includes a number of stages, including vertex shader 100, a hull shader 101 (in DirectX, or a Tessellation Control Shader in Vulkan or OpenGL), a tesselator 102, a domain shader 103 (in DirectX, or a Tessellation Evaluation Shader in Vulkan or OpenGL), a geometry shader 104, a tiler 105, a rasterization stage 106, an early Z (depth) and stencil test stage 107, a renderer in the form of a fragment shading state 108, a late Z (depth) and stencil test stage 109, a blending stage 110, a tile buffer 111, and a tile write out stage 112 that performs downsampling and writeout (multisample resolve).

The vertex shader 100 takes the input data values (vertex attribute values) associated with the vertices, etc., defined for the output to be generated, and processes those data values to generate a set of corresponding “vertex shaded” output data values for use by subsequent stages of the graphics processing pipeline.

For a given output to be generated by the graphics processing pipeline, there may typically be a set of vertices defined for the output in question. The primitives to be processed for the output may then be indicated as comprising given vertices in the set of vertices for the graphics processing output being generated.

The vertex shading operation operates to transform the attributes for each vertex into a desired form for the subsequent graphics processing operations. This may comprise, in particular, transforming vertex position attribute values from the model or object space for which they are initially defined to the screen space in which the output of the graphics processing system is to be displayed, modifying the input data to take account of the effect of lighting in the image to be rendered, etc.

The vertex shading operation may also convert the originally defined vertex position coordinates to a different, e.g. lower precision, form to be used later on in the graphics processing pipeline.

The hull shader 101 performs operations on sets of patch control points and generates additional data known as patch constants. The tessellation stage 102 subdivides geometry to create higher order representations of the hull, and the domain shader 103 performs operations on vertices output by the tessellation stage (similar to a vertex shader). The geometry shader 104 may (if run) generate primitives such as triangles, points or lines for processing.

Once all the primitives to be rendered have been appropriately processed, e.g. transformed, and/or, e.g. generated by the geometry shader, the tiler 105 then determines which primitives need to be processed for each tile into which the render output has been divided for processing purposes. To do so, the tiler 105 compares the location of each primitive to be processed with the tile positions, and adds the primitive to a respective primitive list for each tile within which it determines the primitive could (potentially) fall. Any suitable and desired technique for sorting and binning primitives into tile lists, such as exact binning, bounding box binning or anything in between, may be used for the tiling process.

Once the tiler 105 has completed the preparation of the primitive tile lists (lists of primitives to be processed for each tile), each tile is then rendered. To do so, each tile is processed by the graphics processing pipeline stages shown in FIG. 1 that follow the tiler 105. Thus, when a given tile is being processed, each primitive that is to be processed for that tile (that is listed in a tile list for that tile) is passed to the rasteriser 106.

The rasterization stage 106 of the graphics processing pipeline 10 operates to rasterise the primitives into individual graphics fragments for processing. In particular, the rasteriser 106, particularly a primitive set-up stage 181 (otherwise known as a triangle set-up unit, TSU) of the rasteriser 106, operates to determine, from the vertex shaded vertices provided to the primitive set-up stage 181, edge information representing each primitive edge of a primitive to be rasterised. This edge information is then passed to a rasterization stage 182 of the rasteriser 106, which rasterises the primitive to sampling points (e.g. pixels) and generates graphics fragments having appropriate positions (representing appropriate sampling positions) for rendering the primitive.

It will be appreciated that, although FIG. 1 shows the primitive set-up stage 181 being part of a single rasterization unit 106, this is not required. It is possible for the primitive set-up stage to be separate from the rasteriser 106, e.g. at a stage of the graphics processing pipeline that is (e.g. immediately) before the rasteriser 106, but after the tiler 105.

The fragments generated by the rasteriser 106 are then sent onwards to the rest of the pipeline for processing.

The early Z/stencil stage 107 performs a Z (depth) test on fragments it receives from the rasteriser 106, to determine if any fragments can be discarded (culled) at this stage. In particular, the early Z/stencil stage 107 compares the depth values of (associated with) fragments issuing from the rasteriser 106 with the depth values of fragments that have already been rendered – these depth values are stored in a depth (Z) buffer that is part of the tile buffer 111 – to determine whether the new fragments are occluded by fragments that have already been rendered (or not). At the same time, an early stencil test is also carried out.

Fragments that pass the fragment early Z and stencil test stage 107 are then sent to the fragment shading stage 108. The fragment shading stage 108 performs the appropriate fragment processing operations on the fragments that pass the early Z and stencil tests, so as to process the fragments to generate the appropriate rendered fragment data.

This fragment processing may include any suitable and desired fragment shading processes, such as executing fragment shader programs on the fragments, applying textures to the fragments, applying fogging or other operations to the fragments, etc., to generate the appropriate fragment data. In the present example, the fragment shading stage 108 is in the form of a shader pipeline (a programmable fragment shader).

There is then a late fragment Z and stencil test state 109, which carries out, amongst other things, an end of pipeline depth test on the shaded fragments to determine whether a rendered fragment can actually be seen in the final image. This depth test uses the Z-buffer value for the fragment’s position stored in the Z buffer in the tile buffer 111 to determine whether the fragment data for the new fragments should replace the fragment data of the fragments that have already been rendered, by comparing the depth values of (associated with) fragments issuing from the fragment shading stage 108 with the depth values of fragments that have already been rendered (as stored in the depth buffer). This late fragment depth and stencil test stage 109 also performs any necessary late alpha and/or stencil tests on the fragments.

The fragments that pass the late fragment test stage 109 are then subjected to, if required, any necessary blending operations with fragments already stored in the tile buffer 111 in the blender 110. Any other remaining operations necessary on the fragments, such as dither, etc. (not shown) are also performed at this stage.

Finally, the (blended) output fragment data (values) are written to the tile buffer 111 from where they can e.g. be output to a frame buffer 113 for display. The depth value for an output fragment is also written appropriately to a Z buffer within the tile buffer 111. The tile buffer stores colour and depth buffers that store an appropriate colour, etc., or Z value, respectively, for each sampling point that the buffers represent (in essence for each sampling point of a tile that is being processed). These buffers store an array of fragment data that represents part (a tile) of the overall render output (e.g. image to be displayed), with respective sets of sample values in the buffers corresponding to respective pixels of the overall render output (e.g. each 2x2 set of sample values may correspond to an output pixel, where 4x multisampling is being used).

The tile buffer is provided as part of RAM that is located on (local to) the graphics processing pipeline (chip).

The data from the tile buffer 111 is input to a tile write out unit 112, and then output (written back) to an external memory output buffer, such as a frame buffer 113 of a display device (not shown). The display device may comprise, for example, a display comprising an array of pixels, such as a computer monitor or a printer.

The tile write out unit 112 downsamples the fragment data stored in the tile buffer 111 to the appropriate resolution for the output buffer (such that an array of pixel data corresponding to the pixels of the output device is generated) to generate output values (pixels) for output to the output buffer.

Once a tile of the render output has been processed and its data exported to a main memory (e.g. to a frame buffer 113 in a main memory) for storage, the next tile is then processed, and so on, until sufficient tiles have been processed to generate the entire render output (e.g. frame to be displayed). The process is then repeated for the next render output (e.g. frame) and so on. It should be noted that multiple tiles may be processed concurrently, for example each execution unit (e.g. shader core) may process a separate tile in parallel.

Other arrangements for a graphics processing pipeline are or course possible. The graphics processing pipeline 10 may be executed on and implemented by an appropriate graphics processing unit (GPU) that includes the necessary functional units, processing circuitry, etc., operable to execute the graphics processing pipeline stages.

In order to control a graphics processor (GPU) that is implementing a graphics processing pipeline to perform the desired graphics processing pipeline operations, the graphics processor typically receives commands and data from a driver, e.g. executing on a host processor (e.g. CPU), that indicates to the graphics processor the operations that it is to carry out and the data to be used for the operations.

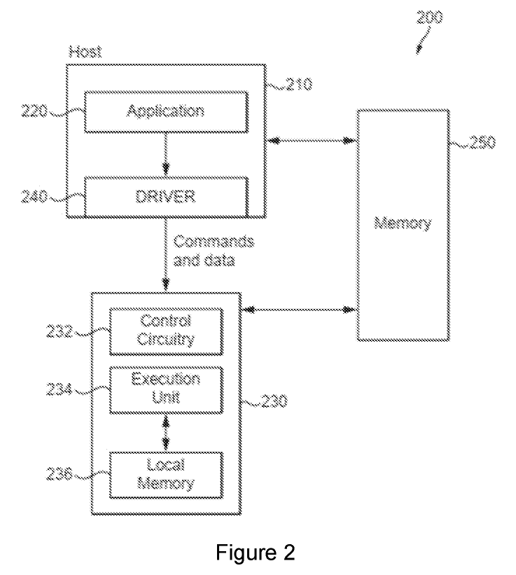

Accordingly, FIG. 2 shows schematically a typical computer graphics processing system 200, in which an application 220 such as a game executes on a host processor 210. When the application 220 requires graphics processing operations to be performed by an associated graphics processing unit (graphics processing pipeline) 230, it generates appropriate Application Programming Interface (API) calls that are interpreted by a driver 240 for the graphics processor 230 running on the host processor 210, to generate appropriate instructions (and data structures) to the graphics processor 230. The graphics processor 230 then generates graphics output required by the application 220 using the instructions (and data structures).

In particular, the graphics processor 230 comprises control circuitry (e.g. an iterator) 232, at least one (and in some embodiments more than one) execution unit 234 and a local memory 236 (e.g. tile buffer) (where there is more than one execution unit, each execution unit preferably has its own associated local memory). A set of instructions is provided to the graphics processor 230 in response to instructions from the application 220 running on the host system 210 for graphics output (e.g. to generate a frame to be displayed). For example, the driver 240 may send commands and data to the graphics processor 230 by writing to memory 250. The control circuitry 232 breaks up the commands and data into one or more processing tasks, and assigns the tasks to the at least one execution unit 234, which processes the tasks in turn and outputs the processing results to the local memory 236. When a task completes, the processing output is written to memory 250.

In order to understand and characterise the performance of a GPU that is implementing a graphics processing pipeline to perform the desired graphics processing pipeline operations, performance queries are typically used. For example, one or more queries may be received by the graphics processor from e.g. a host processor. The performance queries may be used to characterise the performance or processing carried out by the graphics processor.

When monitoring GPU activity while an application is running it is typical to use performance counters. Such performance counters, e.g. those which count numbers of primitives generated, are incremented on the occurrence of relevant events, allowing performance information to be extracted from the GPU. Other examples of events that might be monitored using performance counters include cache misses, a number of fragments rendered or a number of an another particular type of operation performed, or a number of cycles a given element of the graphics processor has been active. It should be recognised that there are many more examples of events that may be monitored using performance counters.

Graphics APIs such as Vulkan/GLES and DirectX provide performance query mechanisms that can be employed by application developers to identify the causes of bottlenecks or inefficient workloads with performance counters. Performance queries are typically defined by query begin and query end commands. Relevant performance counters will be incremented on occurrence of a relevant event, for example both inside and outside a query window. Performance queries sample the performance counters between the query begin and query end commands. Multiple types of performance query can be chosen, such as occlusion queries, primitives generated queries, pipeline statistics queries and performance statistics queries.

Vulkan and GLES APIs define performance queries that allow an application to maintain a pointer to a current query object which is incremented on events. A drawback of the performance queries provided by Vulkan and GLES APIs is that it is only possible to have a single active query of each query type at any given time. While the DirectX API allows multiple concurrent active query objects of each query type, and since there is no upper bound on the number of queries it can become impractical to maintain sets of pointers of active query objects.

The DirectX API defines a global running counter for each query event type. A query begin or end command simply samples the current value of the running counter, and the final query object value is the difference between the 'end' sample and the 'begin' sample. As such, only the difference between the sample values is relevant; the sample values themselves are not of significance.

An important consequence of use of the running counter is that there is a global ordering requirement: all events from a former draw call must be made visible in the running counter before events of a later draw call can be made visible. This is important since an unbounded number of query objects may sample 'begin' or 'end' on a draw call boundary. If there is a query begin at a boundary between draw calls, and then a query end at another boundary between draw calls, then strict ordering of draw calls is required to prevent pollution of the performance query/results with values from other draw calls.

In a tile-based GPU, draw call execution is not globally ordered. Draw calls are not executed to completion independently, and primitives for draw calls are distributed to tiles and the tiles are executed without synchronization. Furthermore, each tile could have some portion of primitives from more than one draw call (e.g. every draw call within a render pass). Therefore, when implementing tile-based graphics processing, the results of a performance query on a particular draw call could become polluted with values from other draw calls

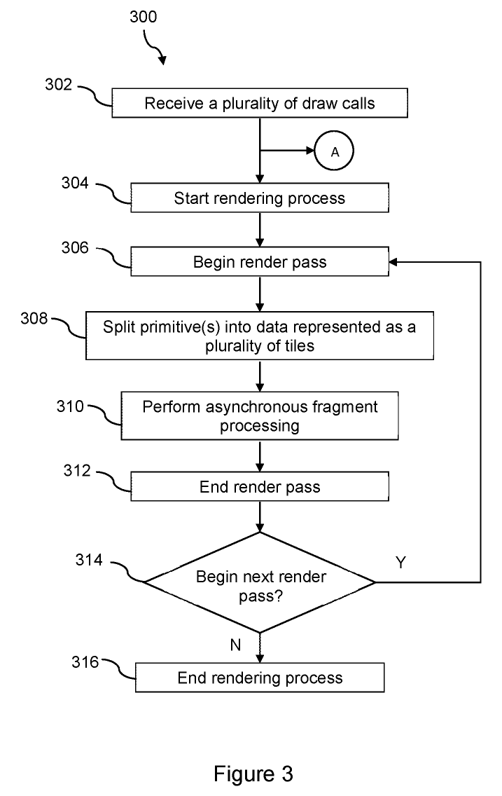

FIG. 3 shows a method 300 of operating a tile-based graphics processor, such as the graphics processor 230 of FIG. 2, for determining a performance metric of one or more draw calls. Advantageously, the method 300 allows processing of performance queries in parallel with the tile-based rendering process. Particularly, the method 300 allows a tile-based rendering process to continue without having to wait for the results of the performance metric to be determined, while also providing a mechanism for making query object updates appear to be globally ordered.

At step 302, the method 300 comprises receiving, by a graphics processor, a plurality of draw calls. For example, the graphics processor 230 may receive a plurality of draw calls from the application 220 via the driver 220. Each draw call received in step 302 comprises one or more primitives. Each “primitive” is typically in the form of a simple polygon, such as a triangle.

At step 304, the method 300 comprises starting a rendering process. For example, the rendering process may be carried out by a graphics processor, such as the graphics processor 230 shown in FIG. 2.

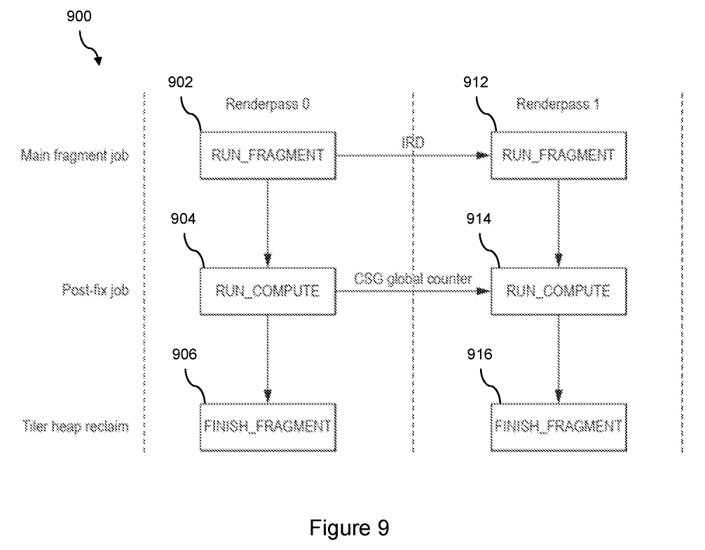

At step 306, the method 300 comprises beginning a render pass, such as a first render pass (see e.g. “Renderpass 0” in FIG. 9). By “render pass” it is meant the rendering of a to-be-rendered object. A render pass can be considered as a set of rendering instructions submitted by an application, such as the application 220 shown in FIG. 2, to a graphics processing unit, such as the graphics processor 230 shown in FIG. 2. Each render pass includes one draw call or a plurality of draw calls. As will be appreciated, any suitable number of draw calls may be included in a render pass, such as 1, 10 or 1000 draw calls.

At step 308, the method 300 comprises splitting the primitives into data represented as a plurality of tiles. The plurality of tiles into which the primitives are split in step 308 correspond to at least portions of the render output. Each primitive may be spread across multiple tiles, and each tile could have some portion of primitives from more than one draw call (e.g. every draw call within the render pass).

At step 310, the method 300 comprises performing, by the tile-based graphics processor on the data represented as a plurality of tiles, asynchronous fragment processing to generate a render output. By “asynchronous fragment processing” it is meant that the tiles into which the primitives are split are executed by the graphics processor 230 without synchronization.

At step 312, the method 300 comprises ending the render pass (e.g. “Renderpass 0”). At this stage, rendered fragment data will be written out to an external memory, such as a frame buffer or the memory 250 shown in FIG. 2, for use.

After step 312, the method 300 proceeds to step 314. On reaching step 314, if there is another render pass to be processed (e.g. “Renderpass 1”), then the “N” branch from step 314 will be followed. On following the “N” branch from step 314, method 300 returns to step 306 where the next render pass begins and steps 306-312 are carried out for this next render pass. As will be appreciated, the rendering process may include any suitable number of render passes, such as 1, 10 or 1000 render passes.

If on reaching step 314 there are no further render passes to be processed, the method 300 proceeds to step 316 where the rendering process ends.

As noted above, at step 302 the method 300 comprises receiving, during the rendering process, a plurality of draw calls. Performance queries may be received during the rendering process to monitor or determine performance of the processor during execution of the draw calls. The queries may be used to characterise the performance or processing carried out by the graphics processor.

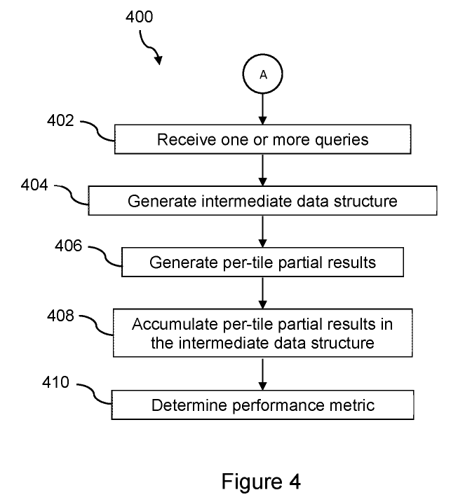

Accordingly, FIG. 4 shows a method 400 for determining a performance metric of one or more draw calls. The method 400 may be considered a sub-method of the method 300 shown in FIG. 3. In particular, the method 400 can be carried out after step 302 (i.e. after draw calls have been received in step 302) and e.g. in parallel with (and independently of) steps 306-316 of method 300.

At step 402, the method 400 comprises receiving, during the rendering process, one or more queries. Each query relates to the performance metric of the subset of the plurality of draw calls received in step 302 of the method 300. A plurality of queries may be received in step 402 such that multiple queries may overlap/operate simultaneously.

Each query received at step 402 will be a performance query and will have a query type, such as occlusion query, primitives generated query, pipeline statistics query and performance statistics query. As will be appreciated, any suitable type of query may be received at step 402. In examples, at least one query of the one or more queries is an occlusion query, a primitives query or a pipeline statistics query.

The result of an occlusion query may be a count of how many fragments are visible, or how many fragments are occluded. The result of a primitives query may be a count of how many primitives have been generated. The result of a pipeline statistics query or performance statistics query is a set of counters or a set of events, related to various points in the graphics pipeline. For example, how many vertex shader invocations were launched within a draw call, how many fragment shader invocations were launched within a draw call, how many primitives have been generated.

At step 404, the method 400 comprises generating, in storage associated with the graphics processor, at least one intermediate data structure for accumulating per-tile partial results of the performance metric for each of the one or more draw calls. The intermediate data structure is a data structure in which the per-tile partial results of the performance metric can be accumulated according to the draw call to which the per-tile partial results of the performance metric correspond.

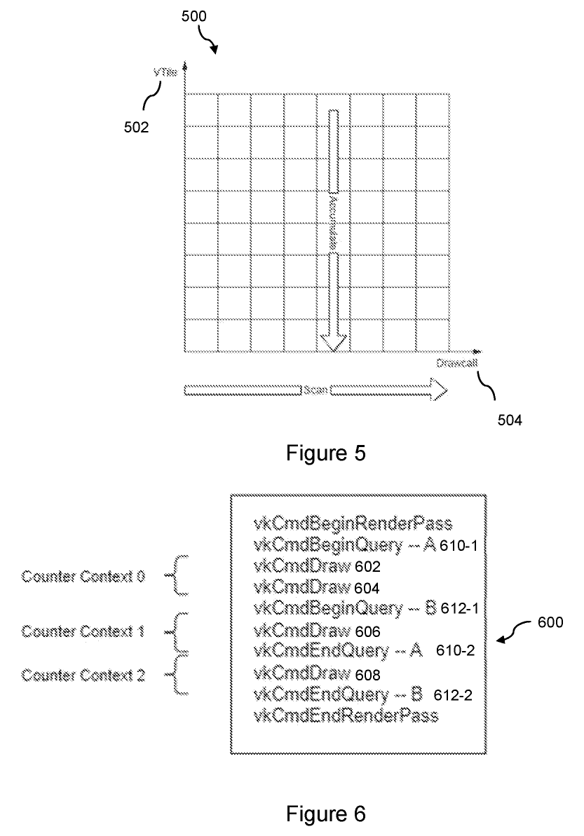

FIG. 5 shows an example of flow in which, for a given query, a performance metric value can be calculated. The final performance metric value represents a sum of the performance metric values for a number of draw calls. The fragment processing for each draw call is executed as a plurality of tiles, with each tile being processed asynchronously with respect to the other tiles. This presents difficulties for sampling performance counters at draw call boundaries since, at any given time, the graphics processor may be operating on different draw calls for different tiles.

FIG. 5 shows how, in accordance with the present disclosure, performance counters aligned to draw call boundaries can be calculated. As represented by the vertical arrow, for each tile 502 a per-tile partial result is accumulated for each draw call for which fragment processing is carried out. The per-tile partial results are accumulated into a per-draw call accumulated value. Thus, when fragment processing for the renderpass has concluded, there will be a plurality of per-draw call accumulated values representing the sum of the performance metric values for the tiles making up the respective draw calls. Since the accumulation of the per-tile partial results is commutative, the per-draw call accumulated values are not dependent on the order in which the per-tile partial results were accumulated.

Once the renderpass has finished, the performance metric value associated with the performance query can be calculated by running a post-fix shader which calculates a sum of the per-draw call accumulated values for the draw calls 504 for which sampling was configured with the performance query. Thus, a total performance metric value can be calculated for the appropriate draw calls based on a sum of the per-tile partial results for the tiles making up those draw calls.

The intermediate data structure 500 allows the per-tile partial results for a particular query type to be accumulated during the render process, which uses asynchronous fragment processing. Where multiple query types are received, multiple intermediate data structures 500 will be required, one intermediate data structure 500 for each query type.

Returning to FIG. 4, at step 406 the method 400 comprises generating per-tile partial results of the performance metric, wherein each of the per-tile partial results are associated with a respective tile and a respective query. For example, where a query is a primitives generated query, the per-tile partial results correspond to the number of primitives generated within particular tiles when executing particular draw calls.

In examples, each query received in step 402 comprises a begin command (e.g. “vkCmdBeingQuery” or “BEGIN_QUERY”) and an end command (“vkCmdEndQuery” or “END_QUERY”). The graphics processor 230 can implement the begin/end commands in any suitable manner in accordance with examples of the present technology. Each query begin and end command executes at a draw call boundary, and at least one draw call will be executed between the begin command and end command. On execution of a begin command relating to a particular query, a counter of a current query object will be incremented on relevant events (e.g. on generation of primitives), thereby generating a partial result.

At step 408, the method 400 comprises accumulating the partial results in the at least one intermediate data structure 500 on a per-draw call basis. Accumulating the partial results in the at least one intermediate data structure 500 comprises, for each partial result, adding that partial result to the intermediate data structure 500 according to the draw call to which that partial result corresponds.

Use of the intermediate data structure 500 to accumulate per-tile partial results for each draw call is advantageous, since it prevents values relating to a particular performance query for a particular draw call from being polluted with values from other draw calls. The intermediate data structure 500 (and methods 300/400 more generally) provide a mechanism for making query object updates appear to be globally ordered.

In examples, the per-tile partial results are accumulated in the at least one intermediate data structure 500 using an atomic operation, such as an atomic add function. By “atomic operation” it is meant a read-modify-write sequence that is performed without interference from another requester. By “atomic add function” it is meant modification of data in a particular region of memory, while ensuring that writes from other requestors do not corrupt the data.

At step 410, the method 400 comprises determining the performance metric, wherein the performance metric corresponds to at least a subset of the received plurality of draw calls. For example, where a query is a primitives generated query, the performance metric corresponds to the total number of primitives generated by a particular draw call (or plurality of draw calls) across all tiles of the render output.

The determination of the performance metric at step 410 is based on accumulated values generated for each of the received draw calls. Each accumulated value corresponds to one or more draw calls of the plurality of draw calls received in step 302 of the method 300. In examples, multiple draw calls (e.g. draw calls 602 and 604 shown in FIG. 6) may contribute to the same accumulated value. As is explained in further detail below, a “counter context” can be defined and used to accumulate events from multiple draw calls.

As represented by the vertical arrow in FIG. 5, for each tile 502 a per-tile partial result is accumulated for each draw call for which fragment processing is carried out. The per-tile partial results are accumulated into a per-draw call accumulated value. Thus, when fragment processing for a renderpass has concluded, there will be a plurality of per-draw call accumulated values representing the sum of the performance metric values for the tiles making up the respective draw calls. Since the accumulation of the per-tile partial results is commutative, the per-draw call accumulated values are not dependent on the order in which the per-tile partial results were accumulated.

Once a renderpass has finished, the performance metric value associated with the performance query can be calculated by running a post-fix shader which calculates a sum of the per-draw call accumulated values for the draw calls 504 for which sampling was configured with the performance query. Thus, a total performance metric value can be calculated for the appropriate draw calls to which the query relates, based on a sum of the per-tile partial results for the tiles making up those draw calls.

FIG. 6 shows an example render pass 600. Example render pass 600 may be executed as part of method 300 i.e. in steps 306-312.

Render pass 600 has four draw calls 602, 604, 606 and 608 and two performance queries 610, 612. The four draw calls 602, 604, 606 may be received as part of method 300 i.e. at step 302. The two performance queries 610, 612 may be received as part of method 400 i.e. at step 402.

Performance queries 610, 612 can be any suitable type of query, such as occlusion queries, primitives queries or pipeline statistics queries and/or performance statistics queries. The two performance queries 610, 612 can be of the same or different query types.

In an example, the first performance query 610 is a primitives query. This means that the first performance query 610 counts the number of primitives generated when processing all of the draw calls between the beginning 610-1 and end 610-2 of the first performance query 610.

As shown in FIG. 6, the beginning 610-1 of the first performance query 610 and end 610-2 of the first performance query 610 surround the first three draw calls 602, 604 and 606. This means that the first performance query 610 will count the number of primitives generated when draw calls 602, 604 and 606 are processed by the graphics processor 230.

In this example, the second performance query 612 is also a primitives query. This means that the second performance query 612 counts the number of primitives generated when processing all of the draw calls between the beginning 612-1 and end 612-2 of the second performance query 612. As will be appreciated, in further examples the second performance query 612 may be another type of query, such as an occlusion query.

As shown in FIG. 6, the beginning 612-1 of the second performance query 612 and end 612-2 of the second performance query 612 surround the third and fourth draw calls 606 and 608. This means that the second performance query 612 will count the number of primitives generated when processing draw calls 606 and 608.

Between each query operation we can define a counter context. In general, it is possible to define counter contexts according to the or each performance query being executed. A counter context is defined by the number and types of active queries. Render pass 600 includes three counter contexts: counter context 0 in which only the first performance query 610 is active; counter context 1 in which the first and second performance queries 610, 612 are active; and counter context 2 in which only the second performance query 612 is active.

As will be appreciated from FIG. 6, draw call 606 is covered by two different concurrently active queries, i.e. the first and second performance queries 610, 612. This is because draw call 606 is located between the respective begin/end commands 610-1/610-2 and 612-1/612-2 of both performance queries 610, 612. Since in this example the first and second performance queries 610, 612 are both primitives queries, simple counting of events directly into queries 610 and 612 would not easily provide accurate results. The present technology addresses such problems and provides a natural solution which can be extended to any number of active queries.

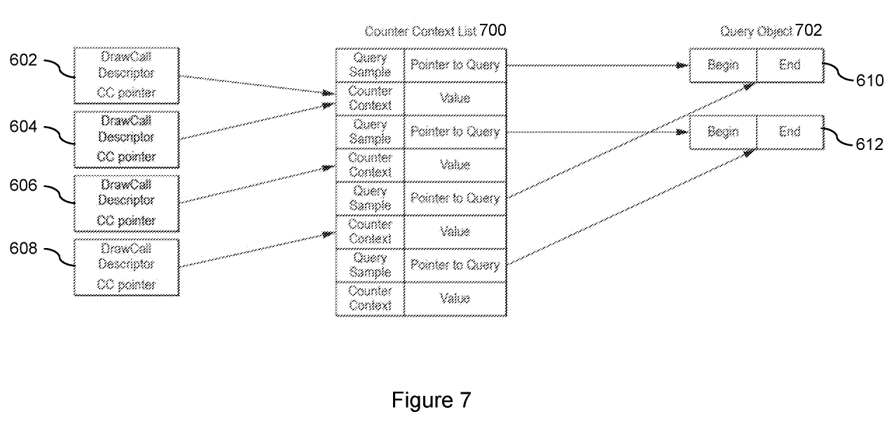

FIG. 7 shows the intermediate data structure (c.f. 500, FIG. 5) in the form of a counter context list 700. The intermediate data structure/counter context list 700 may be stored in memory associated with the graphics processor. The intermediate data structure 700 is an indirection table, and is shown in relation to the four draw calls 602, 604, 606 and 608 and two performance queries 610, 612 of render pass 600. As shown in FIG. 7, each draw call 602, 604, 606 and 608 includes a counter context pointer to its relevant counter context in the intermediate data structure 700. On occurrence of a relevant event, the value in the intermediate data structure 700 associated with the counter context will be incremented.

For some graphics APIs, such as Vulkan/GLES, it is not permitted to use more than a single active query object of any type. Therefore, the counter context indirection may not be needed. For other graphics APIs which allow multiple queries, such as DirectX, it is only necessary to use the intermediate data structure/indirection table 700 in cases where there is more than one query active. For DirectX, a type of optimisation is possible whereby, for example, in the common case where there is only one active query the indirection table 700 may not be used. The indirection table 700 may only be used where there is more than one query active. For example, the indirection table 700 may be allocated and initialized with a begin command of a second query.

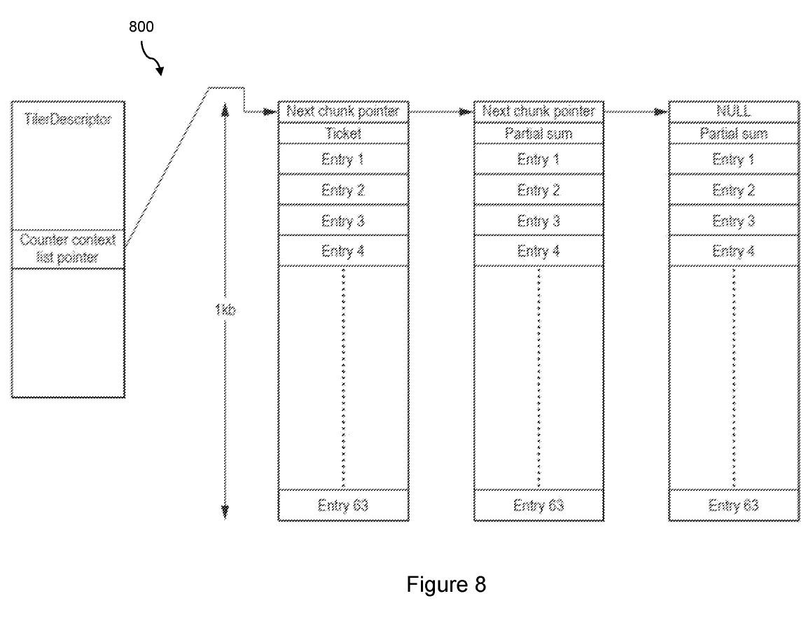

The counter context will be growable in memory associated with the graphics processor and laying it out as a linked list, as shown in FIG. 8, is a suitable solution.

FIG. 9 shows a dependency graph 900 comprising a plurality of execution jobs. The dependency graph 900 includes a first render pass (“Renderpass 0”) and a second render pass ("Renderpass 1”).

During each render pass, a RUN_FRAGMENT job may be run by the graphics processor 230 as a Main fragment job, and a RUN_COMPUTE job may be run by a Post-fix shader as a Post-fix job. Each RUN_COMPUTE job may relate to step 410 of method 400, while each RUN_FRAGMENT job may relate to the remaining steps of methods 300/400. Once the RUN_FRAGMENT and RUN_COMPUTE jobs for a renderpass are complete, a FINISH_FRAGMENT job may be run by the graphics processor as a Tiler heap reclaim.

As shown in FIG. 9, there may be an execution dependency (see arrow labelled “IRD” for Image Region Dependency in FIG. 9) between the RUN_FRAGMENT job of Renderpass 0 and the RUN_FRAGMENT job of Renderpass 1. Image Region Dependency (IRD) is a type of execution dependency which provides an optimized way to handle execution dependencies between fragment jobs. A counter, which is global within the execution environment of a Command Stream Group (CSG) and associated with the query type, is passed between the RUN_COMPUTE jobs of Renderpass 0 and Renderpass 1.

The job and data dependencies of the RUN_FRAGMENT and RUN_COMPUTE jobs of neighbouring render passes are visualized in FIG. 9. Importantly, there is no dependency between RUN_FRAGMENT job of Renderpass 1 and the RUN_COMPUTE job of Renderpass 0. This allows the RUN_FRAGMENT job of Renderpass 1 to proceed without waiting for the RUN_COMPUTE job of Renderpass 0 to be completed.

As shown in FIG. 9, execution of the post-fix compute job RUN_COMPUTE is decoupled from the execution of the Main fragment jobs RUN_FRAGMENT of subsequent render passes. The compute job execution may be deferred since the next fragment job does not depend on its completion. There is a hard dependency between the fragment job and post-fix shader associated with the same renderpass, but the next fragment job does not depend on the post-fix job of the previous renderpass. Post-fix shaders depend on each other and are globally ordered in order to emulate the global ordering of the running count.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as VerilogTM or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a "processor", may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term "processor" or "controller" should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method of operating a tile-based graphics processor for determining a performance metric of one or more draw calls, the method comprising:
receiving, during a rendering process, a plurality of draw calls, each draw call of the plurality of draw calls comprising one or more primitives;
splitting the one or more primitives into data represented as a plurality of tiles, and performing, by the tile-based graphics processor on the data represented as a plurality of tiles, asynchronous fragment processing to generate a render output;
generating, in storage associated with the graphics processor, at least one intermediate data structure for accumulating partial results of the performance metric for each of the received plurality of draw calls;
generating per-tile partial results of the performance metric, wherein each of the per-tile partial results are associated with a respective tile of the plurality of tiles;
accumulating the per-tile partial results in the at least one intermediate data structure on a per-draw call basis to generate an accumulated value for each of the one or more draw calls; and
determining, based on the accumulated values for the one or more draw calls, the performance metric, wherein the one or more draw calls correspond to at least a subset of the received plurality of draw calls.

2. The method of claim 1, wherein the plurality of tiles correspond to portions of the render output.

3. The method of claim 1, wherein the method further comprises receiving, during the rendering process, one or more queries, wherein each query relates to a given performance metric of a respective subset of the received plurality of draw calls, wherein the method comprises, for each query, generating per-tile partial results for the given performance metric, accumulating the per-tile partial results, and determining, based on the accumulated values, the performance metric for the respective subset of draw calls.

4. The method of claim 3, wherein each query comprises a begin command and an end command.

5. The method of claim 4, wherein each begin command and each end command executes at a draw call boundary.

6. The method of claim 3, wherein at least one query of the one or more queries is an occlusion query, a primitives generated query, a pipeline statistics query or a performance statistics query.

7. The method of claim 3, wherein each query is indicative of one or more performance metrics sampled by that query, wherein the method comprises generating, in the storage associated with the graphics processor, an intermediate data structure for each performance metric sampled by the one or more queries.

8. The method of claim 1, wherein accumulating the per-tile partial results in the at least one intermediate data structure comprises, for each per-tile partial result, adding the per-tile partial result to the accumulated value in the intermediate data structure according to the draw call to which that per-tile partial result corresponds.

9. The method of claim 1, wherein accumulating the per-tile partial results in the at least one intermediate data structure comprises, for each draw call of the plurality of draw calls, using an atomic add function.

10. The method of claim 1, wherein determining the performance metric comprises performing a prefix sum for each draw call of the one or more draw calls.

11. The method of claim 1, wherein each accumulated value corresponds to one draw call of the received plurality of draw calls.

12. A graphics processor comprising at least one execution unit with an associated storage element, the at least one execution unit is operable to perform a method comprising:
receiving, during a rendering process, a plurality of draw calls, each draw call of the plurality of draw calls comprising one or more primitives;
splitting the one or more primitives into data represented as a plurality of tiles, and performing, by the tile-based graphics processor on the data represented as a plurality of tiles, asynchronous fragment processing to generate a render output;
generating, in the storage associated with the graphics processor, at least one intermediate data structure for accumulating partial results of the performance metric for each of the received plurality of draw calls;
generating per-tile partial results of the performance metric, wherein each of the per-tile partial results are associated with a respective tile of the plurality of tiles;
accumulating the per-tile partial results in the at least one intermediate data structure on a per-draw call basis to generate an accumulated value for each of the one or more draw calls; and
determining, based on the accumulated values for the one or more draw calls, the performance metric, wherein the one or more draw calls correspond to at least a subset of the received plurality of draw calls.

13. The graphics processor of claim 11, wherein the graphics processor is to execute a post-fix shader.

14. The graphics processor of claim 11, wherein the post-fix shader is configured to determine, based on the accumulated values, the performance metric.

15. A non-transitory computer readable storage medium storing software code which, when executing on a processor, performs a method of operating a graphics processor comprising at least one execution unit with an associated storage element, the at least one execution unit is operable to perform a method comprising:
receiving, during a rendering process, a plurality of draw calls, each draw call of the plurality of draw calls comprising one or more primitives;
splitting the one or more primitives into data represented as a plurality of tiles, and performing, by the tile-based graphics processor on the data represented as a plurality of tiles, asynchronous fragment processing to generate a render output;
generating, in storage associated with the graphics processor, at least one intermediate data structure for accumulating partial results of the performance metric for each of the one or more draw calls;
generating per-tile partial results of the performance metric, wherein each of the per-tile partial results are associated with a respective tile of the plurality of tiles;
accumulating the per-tile partial results in the at least one intermediate data structure on a per-draw call basis to generate an accumulated value for each of the one or more draw calls; and
determining, based on the accumulated values for the one or more draw calls, the performance metric, wherein the one or more draw calls correspond to at least a subset of the received plurality of draw calls.
